(19) United States
(12) Patent Application Publication
(10) Pub. No.: US 2006/0268715 A1
(43) Pub. Date: Nov. 30, 2006

(54) Method and apparatus for transmitting management information in a wireless communication system

(75) Inventors: Juan Carlos Zuniga, Montreal (CA); Catherine Livet, Montreal (CA); John L. Tomici, Southold, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/417,823

(22) Filed: May 4, 2006

Related U.S. Application Data
(60) Provisional application No. 60/678,643, filed on May 6, 2005.

(51) Int. Cl. H04J 1/16

(52) U.S. Cl. 370/235; 370/328; 370/256; 370/338; 370/230

(57) ABSTRACT

In a wireless communication system comprising a plurality of mesh points (MPs), a method and apparatus for transmitting management information includes a first MP transmitting a management frame to a second MP, wherein the management frame includes the medium access control (MAC) address of a destination MP. The second MP receives the management frame from the first MP and determines if it is the destination MP. The second MP updates the management frame if the second MP determines it is not the destination MP, and transmits the management frame to a third MP. The transmissions terminate when the data reaches the destination MP.

### CROSS REFERENCE TO RELATED APPLICATION(S)

This application claims the benefit of U.S. Provisional Application No. 60/678,643 filed May 6, 2005, which is incorporated by reference herein as if fully set forth.

### FIELD OF INVENTION

The present invention relates to wireless communication systems. In particular, the present invention relates to a method and apparatus for transmitting management information in a wireless communication system.

### BACKGROUND

Wireless local area networks (WLANs) are becoming more widespread as wireless technology continues to become more advanced. Additionally, many variations of wireless networks may exist in a particular geographic area. For example, a traditional WLAN might be based on a structured system that includes a base station which communicates with wireless devices and routes traffic between them. Another type of wireless network is an ad-hoc network, in which a wireless device communicates with one or more additional wireless devices in a point-to-point technique where wireless devices dynamically connect to, and disconnect from, the network.

As a combination of the traditional WLAN and ad-hoc network, a mesh network may include user devices, terminals, access points (APs), and base stations, which all function as mesh points (MPs). Mesh networks have been garnering increasing support in the standards community due to characteristics such as low-effort coverage extension for WLANs, low-effort and low-complexity self-deploying WLANs, and for their high fault-tolerance and redundancy.

The 802.11 standard currently defines three types of frames: a data frame, a management frame, and a control frame. Data frames are typically configured with two (2), three (3) or four (4) medium access control (MAC) addresses. However, management and control messages are only configured with two (2) MAC addresses, since only two MAC addresses were needed due to the single-hop architecture of existing wireless networks such as BSS star, IBSS ad-hoc, and AP-AP bridge networks.

In a mesh WLAN, however, the exchange of management information via the management frame is often required beyond a single hop from one MP to the next MP. Additionally, individual MPs may be identified by more than one MAC address depending on the number of interfaces with which they may communicate with other MPs.

There is therefore a need to transmit management information, and to uniquely identify the MAC addresses of MPs in a wireless communication system that is not subject to the limitations of the prior art.

### SUMMARY

The present invention is related to a method and apparatus for transmitting management information in a wireless communication system comprising a plurality of mesh points (MPs). In one embodiment, a first MP transmits a management frame to a second MP, wherein the management frame includes the medium access control (MAC) address of a destination MP. The second MP receives the management frame from the first MP and determines if it is the destination MP. The second MP updates the management frame if the second MP determines it is not the destination MP, and transmits the management frame to a third MP. The transmissions terminate when the data reaches the destination MP.

### BRIEF DESCRIPTION OF THE DRAWING(S)

The foregoing summary, as well as the following detailed description of the preferred embodiments of the present invention will be better understood when read with reference to the appended drawings, wherein:

FIG. 1 is a wireless communication system configured in accordance with the present invention;

FIG. 2 is a management frame, in accordance with the present invention;

FIG. 3 is a block diagram of a mesh point (MP) configured to perform a process for transmitting management information, in accordance with the present invention;

FIG. 4 is a flow diagram of a preferred process of transmitting management information, in accordance with the present invention;

FIG. 5 is a signal diagram depicting a plurality of MPs transmitting a management frame, in accordance with the present invention;

FIG. 6 is a signal diagram depicting a plurality of MPs transmitting a management frame, in accordance with an alternative embodiment of the present invention;

FIG. 7 is a modified management frame including mesh link identification; and

FIG. 8 is a modified information element including mesh link identification.

### DETAILED DESCRIPTION OF THE PREFERRED EMBODIMENT(S)

Hereafter, the terminology “mesh point” (MP) refers to a wireless transmit/receive unit (WTRU), a user equipment (UE), a mobile station, a fixed or mobile subscriber unit, a pager, or any other type of device capable of operating in a wireless environment. Additionally, an MP may refer to a base station, a Node-B, a site controller, an access point or any other type of interfacing device in a wireless environment.

The features of the present invention may be incorporated into an integrated circuit (IC) or be configured in a circuit comprising a multitude of interconnecting components.

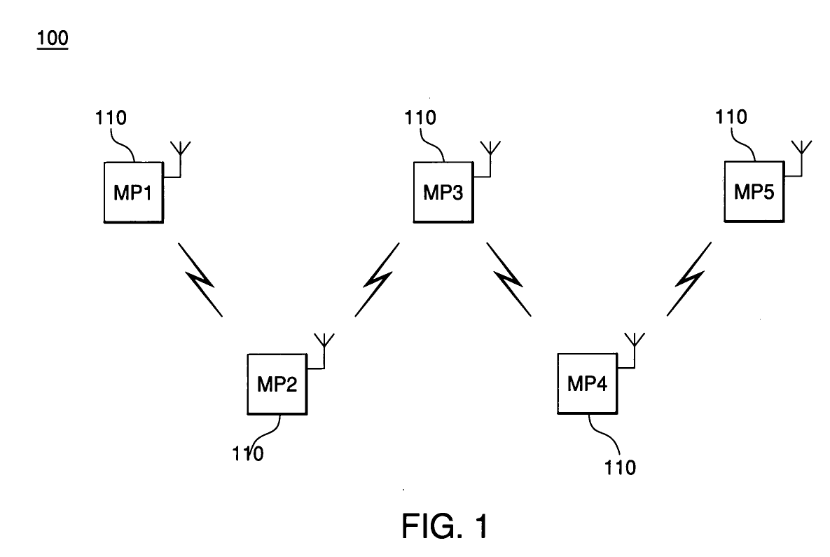

FIG. 1 is a wireless communication system 100, configured in accordance with the present invention. The wireless communication system 100 includes a plurality of MPs 110, capable of communicating with one another. For purposes of describing the invention, the MPs 110 are designated MP1, MP2, MP3, MP4, and MP5. Although five MPs 110 are depicted as communicating in the wireless communication system 100, it should be noted that any number of MPs 110 may be included in the wireless communication system 100. For purposes of describing the present invention, MP1, MP2, MP3, MP4, and MP5 are all substantially similar units.

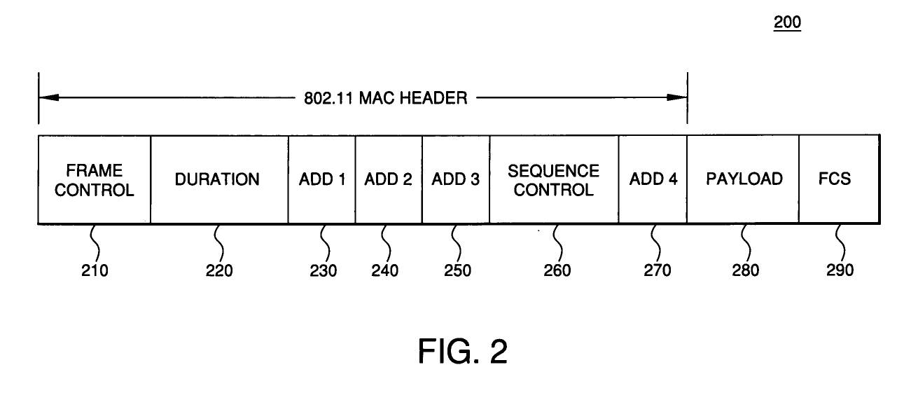

MPs 110 communicate management information to one another by transmitting management control frames. In FIG. 2, a management control frame 200 in accordance with the present invention is shown. The management control frame 200 includes a frame control field 210, a duration field 220, an address one (Add1) field 230, an address two (Add2) field 240, an address three (Add3) field 250, a sequence control field 260, an address four (Add4) field 270, a payload field 280, and a frame checksum (FCS) field 290. Fields 210 through 270 make up the 802.11 MAC header. In the prior art, the frame control field 210 includes a To Distribution System (To DS) field and a From Distribution System (From DS) field. In the present invention, the To DS and From DS fields are replaced with a destination (Dest) MP field and a source MP field. Additionally, in the present invention, the address fields 230, 240, 250 and 270 are utilized as explained in detail below.

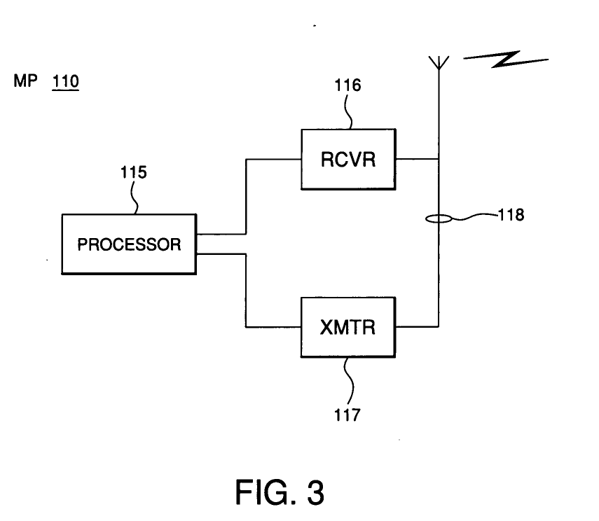

FIG. 3 is a block diagram of an MP 110 configured to perform a process for mesh management in accordance with the present invention. In addition to the nominal components included in a typical MP, the MP 110 includes a processor 115 configured to receive, transmit, and process management frames of the present invention, a receiver 116 in communication with the processor 115, a transmitter 117 in communication with the processor 115, and an antenna 118 in communication with both the receiver 116 and the transmitter 117 to facilitate the transmission and reception of wireless data to and from the MP 110.

In order to transmit a management frame beyond a single hop, the MPs 110 of the present invention utilizes the destination MP, source MP and address fields in an existing frame to indicate to a receiving MP its status related to the management frame. The MP is then able to determine how to process the received management frame, such as whether or not it is intended for the receiving MP or whether the receiving MP should forward the management frame to the next MP.

Referring now to Table 1 (shown below), when a transmitting MP transmits a management frame to a receiving MP, the transmitting MP populates the Dest MP field, Source MP field, and address fields in accordance with Table 1. For example, the destination MP field is populated with a “1” if the MP to receive the frame is the destination MP and a “0” if it is not. The source MP field is populated with a “1” if the MP transmitting the management frame is the source MP and a “0” if it is not. The Address fields are populated with the destination address (DA), the source address (SA), the receiver address (RA), or the transmitter address (TA), depending on the value of the destination MP field and the source MP field as defined in Table 1. In the case where the destination MP field is a “1”, the RA and the DA are the same. Similarly, in the case where the source MP field is a “1”, the TA and the SA are the same. Therefore, purely by way of example, in Table 1 where either the Dest MP or Source MP fields are a “1”, it is possible to use only three address fields (see rows 2 and 3 of Table 1). Similarly, where both the Dest MP and the Source MP fields are populated with a “1”, it is possible to use only two address fields (see row 4 of Table 1). Although a particular arrangement of address fields is shown in Table 1, it is noted that the address fields may be populated in any manner, as desired.

TABLE 1

Frame Control Field

| Dest MP | Source MP | Add1 | Add2 | Add3 | Add4 |
|---|---|---|---|---|---|
| 0 | 0 | RA | TA | DA | SA |
| 0 | 1 | RA | SA | DA | — |
| 1 | 0 | DA | TA | SA | — |
| 1 | 1 | DA | SA | — | — |

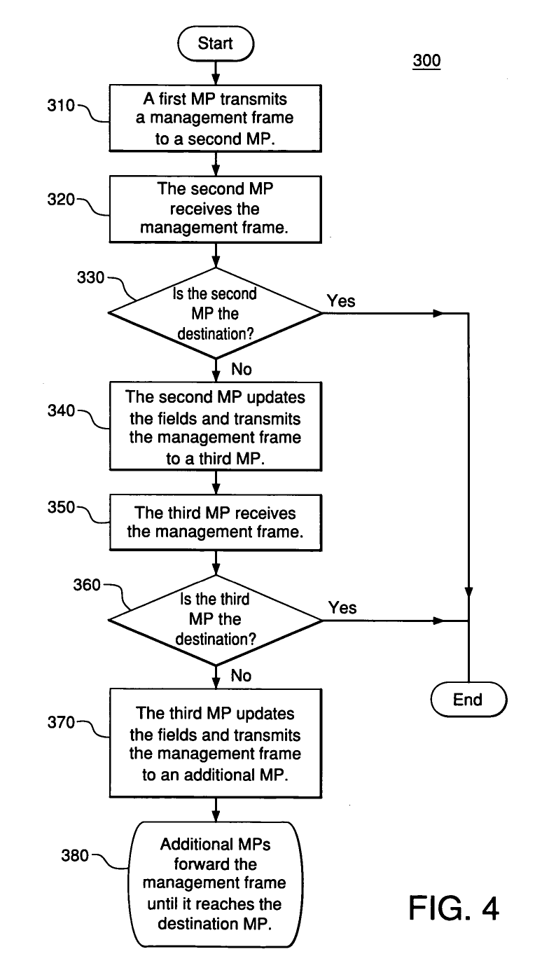

FIG. 4 is a flow diagram generally describing a method 300 for transmitting management information in a wireless communication system, in accordance with the present invention. In step 310, a first MP transmits a management frame to a second MP. The second MP receives the management frame (step 320), and determines whether or not it is the destination MP (step 330) by detecting the value of the dest MP field.

If the destination MP field is a “1”, then the second MP is the destination MP in step 330, and the method 300 terminates. If the second MP is not the destination MP in step 330 (i.e. the destination MP field is a “0”), then the second MP updates the fields accordingly, and transmits the management frame to a third MP (step 340). The third MP receives the management frame (step 350), and determines whether or not it is the destination MP (step 360).

If the third MP is the destination MP in step 360, then the method 300 ends. If the third MP is not the destination MP in step 360, then the third MP updates the fields in the management frame accordingly and transmits the management frame to an additional MP (step 370). Additional MPs forward the management frame accordingly until the management frame is received by the destination MP (step 380). It is noted that the additional MPs may also update the fields in accordance with Table 1 prior to forwarding the management frame.

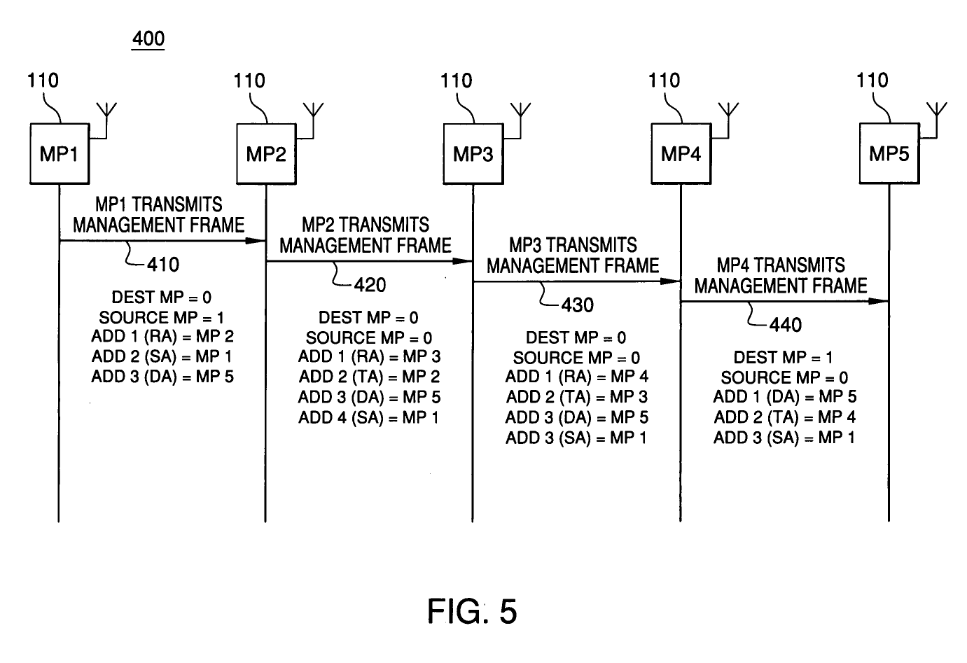

FIG. 5 is an exemplary signal diagram 400 depicting a plurality of MPs 110 (designated MP1, MP2, MP3, MP4, and MP5) transmitting a management frame, in accordance with the method 300. In particular, for purposes of providing an example, a management frame is shown being transmitted from MP1 to MP5 via MP2, MP3, and MP4. In this example, MP1 is the source MP and MP5 is the destination MP.

First, the processor 115 of MP1 transmits the management frame to MP2 ( 410). Since MP1 is the source MP, and MP2 is not the destination MP, the processor 115 updates the fields of the management frame of signal 410 to include the following populated fields: Dest MP=0 and source MP=1. In accordance with Table 1, Add1=MP2 (RA), Add2=MP1 (SA), and Add3=MP5 (DA).

The receiver 116 of MP2 receives the management frame transmitted from MP1 and forwards it to the processor 115 of MP2. The processor 115 determines that MP2 is not the destination MP of the management frame and MP2 transmits the management frame to MP3 ( 420) via the transmitter 117 and antenna 118. Since MP2 is not the source MP and MP3 is not the destination MP, the processor 115 of MP2 updates the fields of the management frame of signal 420 to include the Dest MP=0 and source MP=0. In accordance with Table 1, Add1=MP3 (RA), Add2=MP2 (TA), Add3=MP5 (DA), and Add4=MP1 (SA).

The receiver 116 of MP3 receives the transmitted management frame and forwards it to the processor 115 of MP3. The processor 115 of MP3 then determines that MP3 is not the destination MP of the management frame and MP3 transmits the management frame to MP4 (430. Since MP3 is not the source MP and MP4 is not the destination MP, the processor 115 of the MP3 updates the fields of the management frame in signal 430 to include Dest MP=0 and source MP=0. In accordance with Table 1, Add1=MP4 (RA), Add2=MP3 (TA), Add3=MP5 (DA), and Add4=MP1 (SA).

The receiver 116 of MP4 receives the transmitted management frame and forwards it to the processor 115 of MP4. The processor 115 of MP4 then determines that MP4 is not the destination MP of the management frame and MP4 transmits the management frame to MP5 (440). Since MP5 is the destination MP but MP4 is not the source MP, the processor 115 of MP4 updates the fields of the management frame in signal 440 to include Dest MP=1 and source MP=0. In accordance with Table 1, Add1=MP5 (DA), Add2=MP4 (TA), and Add3=MP1 (SA).

The receiver 116 of MP5 receives the transmitted management frame and forwards it to the processor 115 of MP5. The processor 115 of MP5 then determines that MP5 is the destination MP of the management frame and accepts the management frame. The processor 115 then acts in accordance with the request contained in the management frame. For example, if the management frame was a measurement request for power levels at MP5, then the processor 115 responds to MP1 with the associated measurements.

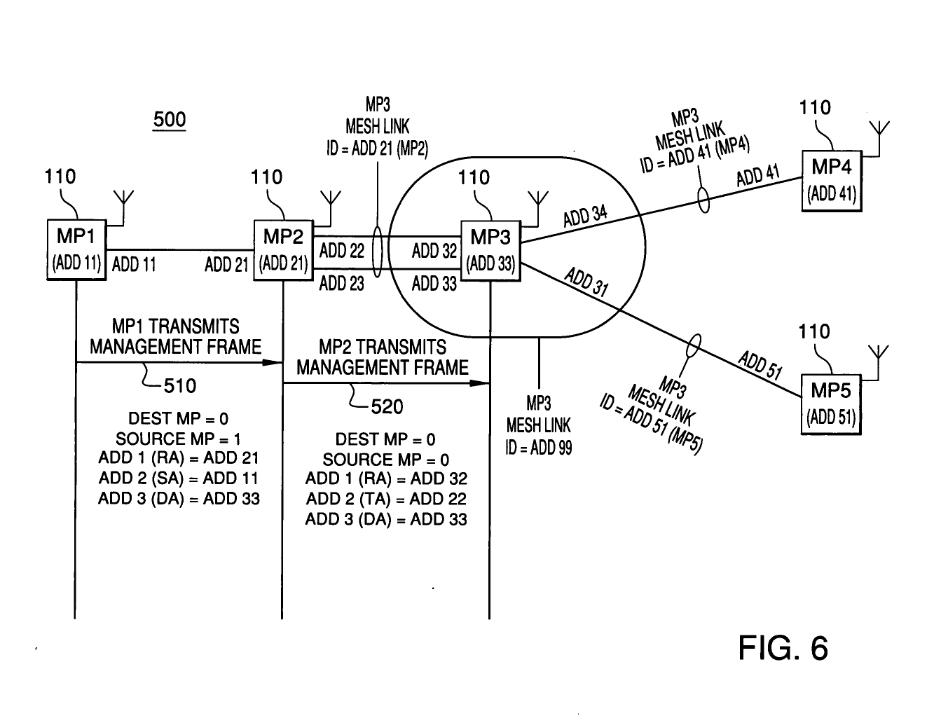

FIG. 6 is a signal diagram 500 depicting a plurality of MPs 110 (designated MP1, MP2, MP3, MP4, and MP5) transmitting a management frame, in accordance with an alternative embodiment of the present invention. In the present embodiment, an MP 110 may support multiple physical links to communicate with other MPs, wherein each physical link has a MAC address. To be identified in the mesh, each MP 110 may have a master address.

In the present example, MP1 may be identified by MAC address 11 (Add11), while MP2, supports three physical links to communicate with other MPs. One link for MP2 is associated with MP1 and designated by MAC address 21 (Add21). Add21 may also be the master MAC address associated with MP2. Additionally, MP2 includes two separate physical links associated with MP3, designated as MAC address 22 (Add22) and MAC address 23 (Add23). In a preferred embodiment, the two separate physical addresses may be associated with different communication protocols. For example, Add22 may be associated with 802.11b while Add23 may be associated with 802.11g.

Also in the present example, MP3 supports four physical links. It may therefore be identified by a master MAC address 33 (Add33), but also includes physical link addresses with the MPs associated with it. Two physical addresses, designated address 32 (Add32) and address 33 (Add33) in association with MP2, an address 34 (Add34) in association with MP4, and physical link address 31 (Add31) in association with MP5. MP4 may be identified by MAC address 41 (Add41), and MP5 may be identified by MAC address 51 (Add51).

In the present example, MP1 transmits a management frame in accordance with the present invention destined for MP3. Since MP1 (Add11) is the source MP and MP2 (Add21) is not the destination MP, the processor 115 of MP1 assigns the fields in accordance with Table 1 such that Dest MP=0 and source MP=1. Accordingly, Add1=Add21 (RA-MP2), Add2=Add11 (SA-MP1), Add3=Add33 (DA-MP3). The processor 115 then transmits the management frame to MP2 (510) via the transmitter 117 and the antenna 118.

The receiver 116 of MP2 receives the transmission and forwards it to the processor 115 of MP2. The processor 115 decodes the management frame and determines that it is not intended for MP2. The processor 115 then updates the fields in the management frame and transmits it to MP3 (520). Since MP2 communicates with MP3 through the physical link identified by MAC address Add32, the processor 115 of MP2 does not recognize MP3 as the destination address. Accordingly, the processor 115 of MP2 assigns Dest MP=0 and source MP=0 to the respective fields. In accordance with Table 1, Add1=Add32 (RA-MP3), Add2=Add22 (TA-MP2), Add3=Add33 (DA-MP3), and Add4=Add11 (SA-MP1).

The receiver 116 of MP3 receives the transmitted management frame from the antenna 118 and forwards it to the processor 115 of MP3. The processor 115 of MP3 decodes the management frame and determines that, even though the Dest MP field is equal to zero, the management frame is intended for MP3 since the master MAC address of MP3 (Add33) populates the Add3 field, which is the destination address (DA).

Although the format of the management frame used in the signal diagram of FIG. 6 is as described above in Table 1, it should be noted that variations to the format may be utilized. The management frame format may be altered to accommodate additional formats, such as the Add1 field indicating the SA, the Add2 field indicating the RA, or any other combination of the address fields or Dest MP and source MP fields.

Referring still to FIG. 6, some MPs 110 may have more than one MP with which they are in communication. For example, MP3 is depicted as communicating with MP2, MP4, and MP5. Accordingly, each mesh link between each MP, such as MP2-MP3, MP3-MP4, and MP3-MP5, is unique in the wireless communication system with respect to every other mesh link. Since the mesh management frame 200 identifies the destination MP, it is only necessary to identify the address of a neighbor MP in order to uniquely identify the mesh link. That is, in order to identify the mesh link between MP3 and MP4 in a management frame transmitted to MP3, a mesh link identifier (ID) need only specify the address of MP4 (Add44). The mesh link ID for the links between MP3 and MP2 is designated Add21 (MP2 's MAC address), while the mesh link ID between MP3 and MP4 is designated Add41 (MP4 's MAC address), and the mesh link ID between MP3 and MP5 is designated Add51 (MP5 's MAC address).

For example, MP1 may transmit a management frame to Add33 (MP3) requesting measurement requests, for maintenance operations, or the like on the mesh link between MP3 and MP4. Since MP3 would be identified as the DA in the management frame, MP1 need only specify the mesh link ID for MP4 (Add41) in order to uniquely identify the link between MP3 and MP4. This may be accomplished by either adding an extension to the management frame 200 that includes the mesh link ID, or by including the mesh link ID in an information element (IE).

Alternatively, a unique mesh link ID may be assigned to a group of mesh links in order to identify that group. For example, referring still to FIG. 6, a mesh link ID 99 is assigned to the mesh links between MP3 and all of its neighbor MPs (MP2, MP4, and MP5). Therefore, when the mesh link ID 99 is identified to MP3, it well recognize all the links associated with MP2, MP4, and MP5.

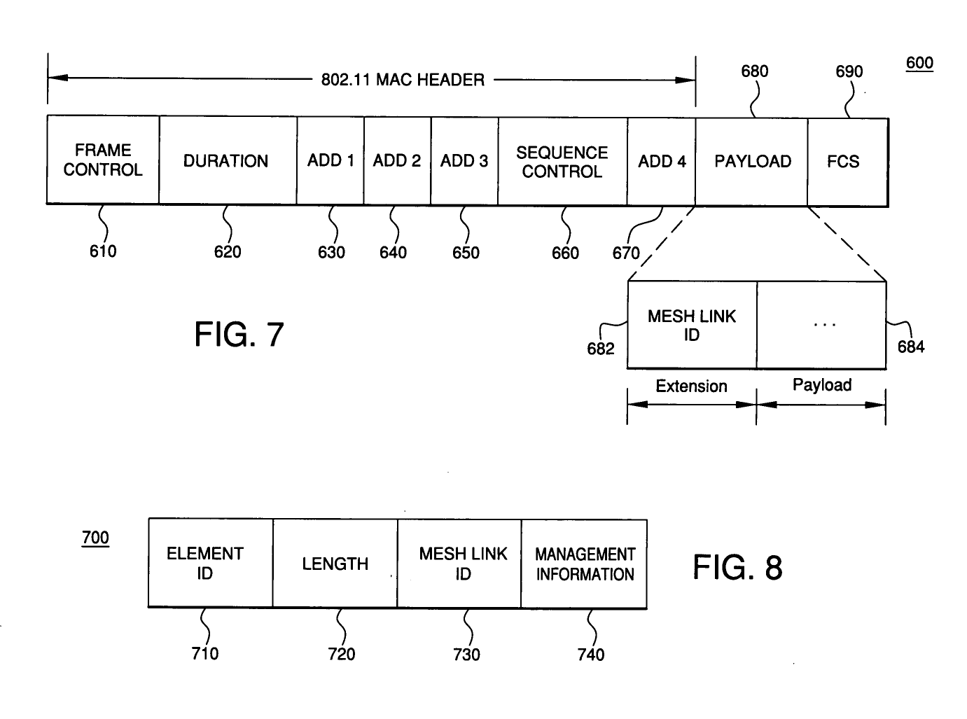

FIG. 7 shows a management frame 600 modified to include mesh link identification. The management frame includes a frame control field 610, duration field 620, Add1 field 630, Add2 field 640, Add3 field 650, sequence control field 660, Add4 field 670, payload field 680 and frame checksum (FCS) field 690. The payload field 680 is further extended to include a mesh link ID field 682 in addition to the payload 684. In this embodiment, the frame control field 610 may specify to the destination MP how the payload field 680 is to be decoded.

In an alternative embodiment of the present invention, the mesh link ID field may be provided within an information element. FIG. 8 shows an information element 700 modified to include an element ID field 710, a length field 720, a mesh link ID field 730, and management information 740. In this case, the management information, such as a measurement request/response, action request/response, or the like, may be transmitted along with the mesh link ID to the destination MP in order to uniquely identify the mesh link upon which measurements/action is requested.

The present invention may be implemented in any type of wireless communication system, as desired. By way of example, the present invention may be implemented in any type of IEEE 802 type system or any other type of wireless communication system. The present invention may also be implemented in software, or as an application running on a processor. The present invention further may be implemented on an integrated circuit, such as an application specific integrated circuit (ASIC), multiple integrated circuits, logical programmable gate array (LPGA), multiple LPGAs, discrete components, or a combination of integrated circuit(s), LPGA(s), and discrete component(s).

Although the features and elements of the present invention are described in the preferred embodiments in particular combinations, each feature or element can be used alone (without the other features and elements of the preferred embodiments) or in various combinations with or without other features and elements of the present invention. For example, in a preferred embodiment of the present invention, specific mesh links are identified by a unique mesh link ID. However, the mesh link may also be identified by the destination MP address coupled with a predetermined extension, or by an independent identifier such as a random number generated to identify the mesh link. The random number may include the MAC address as a seed from which to generate the mesh link ID.

What is claimed is:

1. A method for transmitting management information in a wireless communication system comprising a plurality of mesh points (MPs), the method comprising:
a first MP transmitting a management frame to a second MP, wherein the management frame includes a first medium access control (MAC) address of a destination MP;
the second MP receiving the management frame from the first MP;
the second MP determining if it is the destination MP;
the second MP updating the management frame if the second MP determines it is not the destination MP; and
the second MP transmitting the management frame to a third MP.

2. The method of claim 1 wherein the management frame includes a destination MP field, a source MP field, and a plurality of address fields.

3. The method of claim 2 wherein the destination MP field equals zero if a receiving MP is not the destination MP and equals one if the receiving MP is the destination MP.

4. The method of claim 2 wherein the source MP field equals zero if a transmitting MP is not the source MP and equals one if the transmitting MP is the source MP.

5. The method of claim 2 wherein a first address field is populated with the MAC address of a receiving MP.

6. The method of claim 5 wherein the MAC address of the receiving MP is the MAC address of the destination MP.

7. The method of claim 5 wherein a second address field is populated with the MAC address of a transmitting MP.

8. The method of claim 7 wherein the MAC address of the transmitting MP is the MAC address of the source MP.

9. The method of claim 7 wherein a third address field is populated with the MAC address of a destination MP.

10. The method of claim 9 wherein a fourth address field is populated with the MAC address of a source MP.

11. The method of claim 1 wherein an MP is identified by a plurality of MAC addresses.

12. The method of claim 11 wherein a first MAC address identifies a particular MP in the wireless communication system as a master MAC address of the MP.

13. The method of claim 12 wherein a second MAC address identifies a communication link between the particular MP and a neighbor MP.

14. The method of claim 13 wherein the second MAC address is the MAC address of the neighbor MP.

15. The method of claim 14 wherein the second MAC address identifies the communication mesh link between the particular MP and the neighbor MP in the wireless communication system.

16. The method of claim 15 wherein the management frame includes a mesh link identifier (ID) field, said mesh link ID field identifying the specific mesh link in the wireless communication system.

17. The method of claim 16 wherein the management frame includes a payload field and the mesh link ID field is an extension of the payload field.

18. The method of claim 16 wherein the mesh link ID field is included in an information element.

19. The method of claim 12 wherein a second MAC address identifies a communication link between the particular MP and all neighbor MPs.

20. The method of claim 19 wherein the management frame further comprises a mesh link identifier (ID) field, said mesh link ID field identifying the specific mesh link in the wireless communication system.

21. The method of claim 20 wherein the management frame includes a payload field and the mesh link ID field is an extension of the payload field.

22. The method of claim 20 wherein the mesh link ID field is included in an information element.

23. The method of claim 20 wherein the mesh link ID is generated randomly.

24. The method of claim 23 wherein the mesh link ID is generated using the destination MAC address as a seed.

25. The method of claim 1 wherein the management frame specifies a source MP and a destination MP.

26. In a wireless communication system, a mesh point (MP) comprising:
a receiver;
a transmitter; and
a processor in communication with both the receiver and the transmitter, wherein the processor is configured to control the transmitter to transmit a management frame; and
wherein the management frame includes a medium access control (MAC) address of a destination MP.

27. The MP of claim 26 wherein the processor is further configured to receive a transmitted management frame from the receiver, determine if the MP is the destination MP of the management frame, and update the management frame fields if the MP is not the destination MP.

28. In a wireless communication system comprising a plurality of mesh points (MPs), each MP including an integrated circuit (IC) comprising:
a receiver;
a transmitter; and
a processor in communication with both the receiver and the transmitter, wherein the processor is configured to control the transmitter to transmit a management frame; and
wherein the management frame includes a medium access control (MAC) address of a destination MP.

29. The IC of claim 28 wherein the processor is further configured to receive a transmitted management frame from the receiver, determine if an MP, in which the IC is included, is a destination MP of the management frame, and update the management frame fields if the MP is not the destination MP.
